(19) United States
(12) Patent Application Publication
(10) Pub. No.: US 2022/0147370 A1
(43) Pub. Date: May 12, 2022

(54) MANAGEMENT OF COMPUTING DEVICES

(71) Applicant: Hewlett-Packard Development Company, L.P., Spring, TX (US)

(72) Inventors: Alexandre Santos da Silva Junior, Porto Alegre (BR); Lucas Lemos Rosa, Porto Alegre (BR); Bruno Meybom Pospichil, Porto Alegre (BR); Cassandra Ellen Clark, Fort Collins, CO (US); Derek John Lukasik, Fort Collin, CO (US); Joseph-Jonathan Salzano, Fort Collins, CO (US)

(73) Assignee: Hewlett-Packard Development Company, L.P., Spring, TX (US)

(21) Appl. No.: 17/414,185

(22) PCT Filed: Jul. 30, 2019
(86) PCT No.: PCT/US2019/044071

§ 371 Date: Jun. 15, 2021

(51) Int. Cl. G06F 9/445; G06F 9/50; H04L 67/08; H04L 67/306

(52) U.S. Cl. CPC G06F 9/4451; H04L 67/306; H04L 67/08; G06F 9/5072

(57) ABSTRACT

An example non-transitory computer-readable storage medium includes instructions that, when executed by a processing resource, cause the processing resource to collect user data for a plurality of users and computing device data for a plurality of computing devices. The instructions further cause the processing resource to create a user profile for each of the plurality of users based on the user data. The instructions further cause the processing resource to create a computing device profile for each of the plurality of computing devices based on the computing device data. The instructions further cause the processing resource to identify a quality threshold for a user of the plurality of users. The instructions further cause the processing resource to match, to satisfy the quality threshold, the user of the plurality of users to a computing device of the plurality of computing devices based on the user profile and the computing device profile.

### BACKGROUND

A computing device (e.g., a laptop computing device, a desktop/workstation computing device, a smart/mobile phone, a tablet computing device, etc.) can execute applications for performing various tasks. The type of applications executable on a computing device can vary based on the particular computing device's configuration. Computing devices can be located locally to users. In some cases, a user has a dedicated computing device. In other cases, computing devices are remotely accessible and can be shared by multiple users.

### BRIEF DESCRIPTION OF THE DRAWINGS

The following detailed description references the drawings, in which:

FIG. 1 depicts a connection manager for computing device management according to examples described herein;

FIG. 2 depicts features of the connection manager of FIG. 1 according to examples described herein;

FIG. 3A depicts a user profile according to examples described herein;

FIG. 3B depicts a user profile according to examples described herein;

FIG. 3C depicts a user profile according to examples described herein;

FIG. 3D depicts a table of a computing device profile according to examples described herein;

FIG. 4 depicts a computer-readable storage medium comprising instructions for management of computing devices according to examples described herein;

FIG. 5 depicts a flow diagram of a method for management of computing devices according to examples described herein; and

FIG. 6 depicts a flow diagram of a method for management of computing devices according to examples described herein.

### DETAILED DESCRIPTION

The techniques described herein provide for a connection manager for computing device management such as in a centralized environment. The connection manager collects user data for users and computing device data for computing devices. Using the respective user data and computing device data, the connection manager creates a user model for each of the users and a computing device model for each of the computing devices. Based on the user profile for each of the plurality of users and the computing device profile for each of the plurality of computing devices, the connection manager matches users to computing devices. When a user connects to the connection manager to request a remote session with one of a plurality of computing devices, the connection manager assigns, based on the matching, the user to one of the computing devices. In this way, the connection manager acts as a broker between users and a pool of computing devices shared by the users.

In traditional computing device-based environments, users are assigned a computing device (e.g., a laptop computing device, a desktop/workstation computing device, a smart/mobile phone, a tablet computing device, etc.) such that each computing device has a single owner. In such environments, it is not easy to optimize resource utilization. For example, consider the case of remote users connecting to centralized computing devices. When each user is assigned to a single computing device, inefficiencies occur. For example, the computing device is idle/unused when the user is not connected. Moreover, the user is limited to the capabilities of the assigned computing device.

The present techniques address this shortcoming by providing a connection manager to match users and computing devices and to evaluate and improve the matching over time. For example, in a centralized computing device model, where computing devices are centrally located, managed, and remotely accessed, the connection manager provide herein is capable of observing how users use computing devices and then provide recommendations for matching users to computing devices and for optimizing the use of available computing devices (resources). The matching is performed by identifying a quality threshold to be satisfied and then matching a user to a computing device to satisfy the quality threshold. Examples of quality thresholds include an amount of processing, memory, and/or graphics to support a particular user's demands based on the types of applications the user uses. For example, a quality threshold for a user using video editing applications and three-dimensional rendering applications may be higher than a quality threshold for a user using basic email, web browsing, and office suite software.

The proposed solution provides a connection manager that includes the following components: a data collection engine, a profile engine, a resource mapping engine, and a resource optimization engine. The data collection collects user data about users and computing device data about computing devices, and the profile engine creates user profiles based on the user data and creates computing device profiles based on the computing device data. Using the user profiles and computing device profiles, the matching engine matches users to computing devices. Once matched, the resource optimization engine continues to monitor the users and computing devices to evaluate the matching and provide recommendations for improving the matching and/or improving the computing devices.

An example of an additional benefit of the connection manager for computing device management includes improved assignment (matching) of users to computing devices. For example, if a user typically uses a three-dimensional modeling software application, the connection manager would recognize this usage and match the user to a computing device with a high-end graphics card. Another example benefit of the connection manager is that it enables lower power consumption at the centralized computing device model location, for example, by automatically powering off computing devices not being used and then powering them back up when users typically begin using them again. Another example benefit of the connection manager is that overutilized or underutilized computing devices can be identified and removed or replaced and/or additional computing devices can be added. Yet another example benefit of the connection manager is that it can load balance usage across computing devices to balance the collective life of the computing devices in a pool of computing devices.

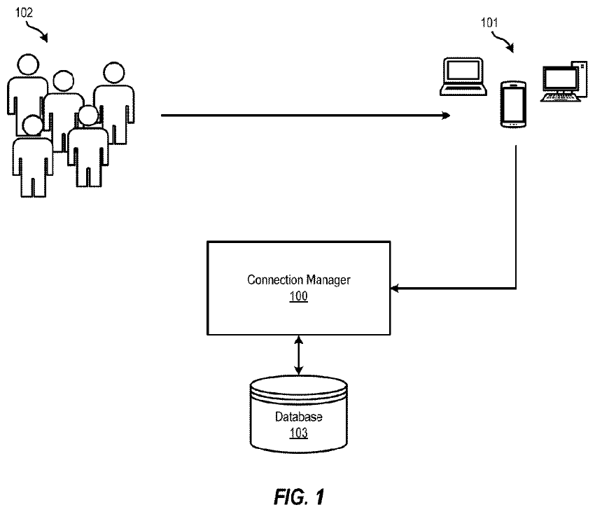

FIGS. 1-3 include components, modules, engines, etc. according to various examples as described herein. In different examples, more, fewer, and/or other components, modules, engines, arrangements of components/modules/engines, etc. can be used according to the teachings described herein. In addition, the components, modules, engines, etc. described herein are implemented as software modules executing machine-readable instructions, hardware modules, or special-purpose hardware (e.g., application specific hardware, application specific integrated circuits (ASICs), field programmable gate arrays (FPGAs), embedded controllers, hardwired circuitry, etc.), or some combination of these.

FIG. 1 relates to components, engines, and modules of a computer processing system, such as a connection manager 100 of FIG. 1. In particular, FIG. 1 depicts a connection manager 100 for computing device management according to examples described herein. In examples, the connection manager 100 is any appropriate type of computer processing system, such as smartphones, tablets, desktops, laptops, workstations, servers, smart monitors, smart televisions, digital signage, scientific instruments, retail point of sale devices, video walls, imaging devices, peripherals, networking equipment, wearable computing devices, or the like.

The connection manager 100 provides computing device management of computing devices 101, which are used by users 102. The computing devices 101 are any appropriate type of computer processing system, such as smartphones, tablets, desktops, laptops, workstations, servers, smart monitors, smart televisions, digital signage, scientific instruments, retail point of sale devices, video walls, imaging devices, peripherals, networking equipment, wearable computing devices, or the like. The users 102 use the computing devices 101 to execute applications, such as word processing applications, electronic mail/messaging applications, video or photo editing applications, three-dimensional modeling applications, multi-media rendering applications, project management applications, computer network management applications, presentation applications, video conferencing applications, and many others.

The connection manager 100 collects data about the computing devices 101 and about the users 102. The connection manager uses the collected data to generate computing device profiles for each of the computing devices 101 and to generate user profiles for each of the users 102. The connection manager 100 then matches at least one of the users 102 with at least one of the computing devices 101 based on the computing device profiles and the user profiles. The matching can be based on the computing device profiles and the user profiles and/or can be based on additional data or information, such as historical computing device data, historical user data, or other data or information.

The connection manager 100 can continue to monitor the computing devices 101 and the users 102 subsequent to the matching to evaluate the matching and perform re-matching based on additional collected data about the users and about the computing devices. For example, as behaviors/patterns of the users 102 change over time, as the computing devices 101 age and/or are modified (e.g., replaced, upgraded, removed, etc.), and the like, the connection manager 100 can re-match the computing devices 101 and the users 102 to improve the functioning of the computing devices 101 and to improve user experiences of the users 102. The connection manager 100 can also monitor sessions (i.e., a user being connected to and using a computing device) to evaluate whether an appropriate computing device was brokered to a user. For example, if a user is experiencing slow performance, the connection manager 100 can end the session and broker a different computing device to the user, which may provide a better-quality session.

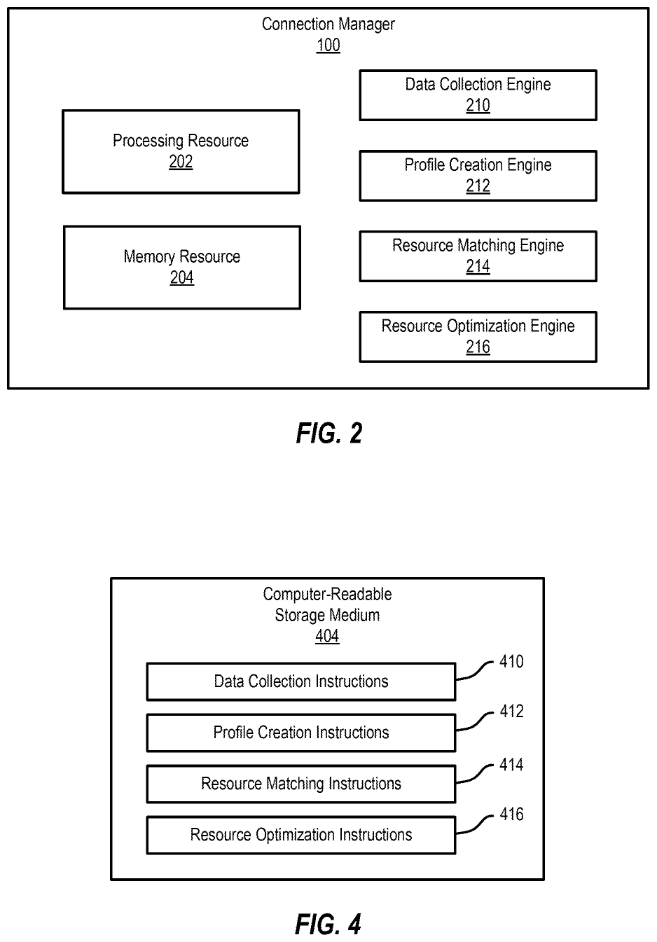

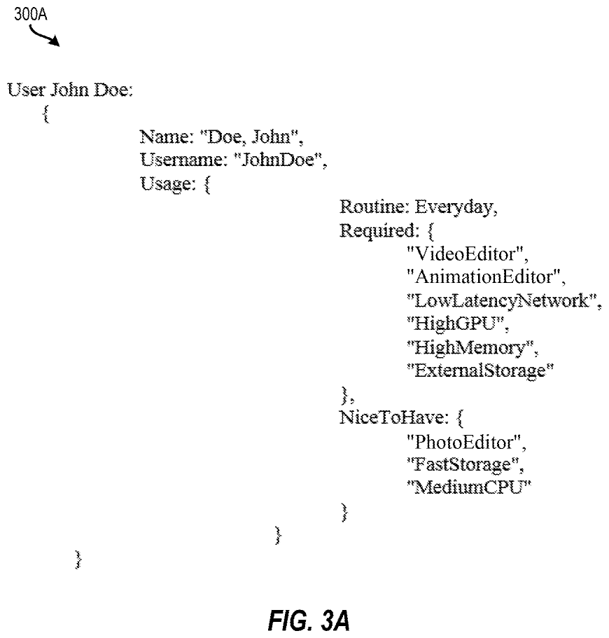

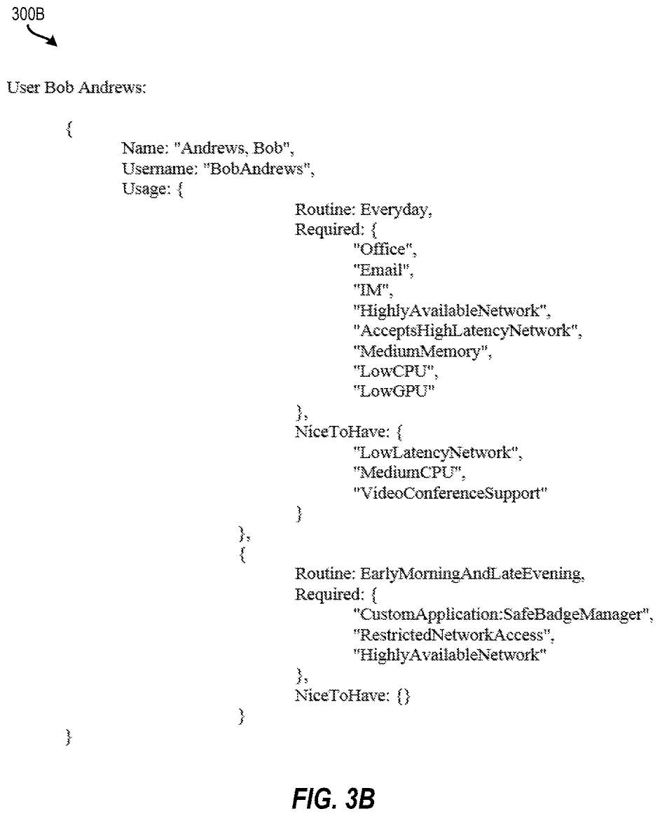

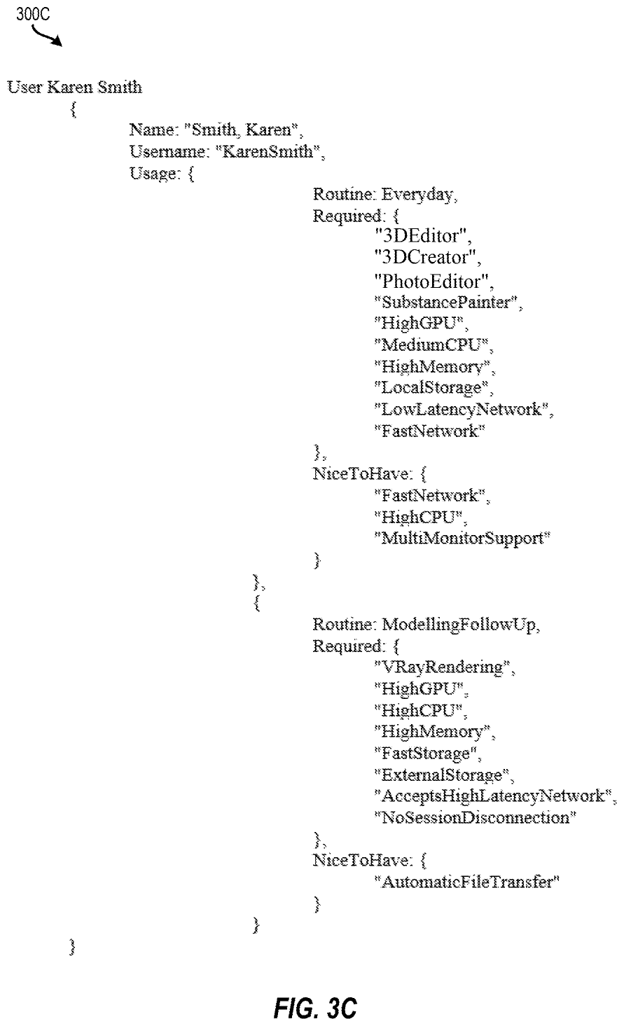

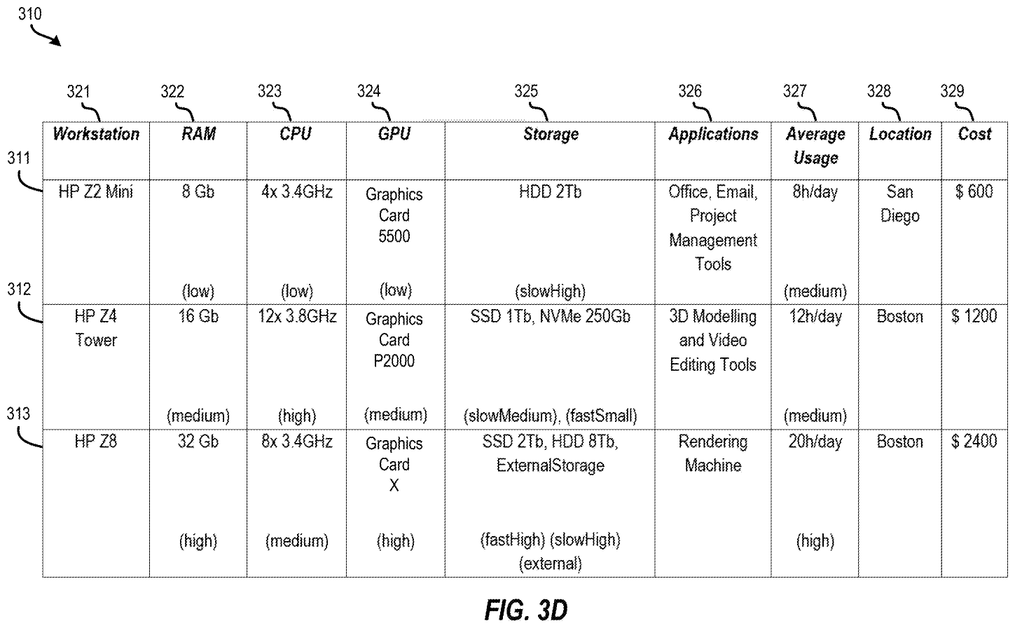

FIG. 2 depicts features of the connection manager 100 of FIG. 1 according to examples described herein. As shown in FIG. 2, the connection manager includes a processing resource 202 that represents any suitable type or form of processing unit or units capable of processing data or interpreting and executing instructions. For example, the processing resource 202 includes central processing units (CPUs), microprocessors, and/or other hardware devices suitable for retrieval and execution of instructions. The instructions are stored, for example, on a non-transitory tangible computer-readable storage medium, such as memory resource 204 (as well as computer-readable storage medium 404 of FIG. 3), which may include any electronic, magnetic, optical, or another physical storage device that store executable instructions. Thus, the memory resource 204 may be, for example, random access memory (RAM), electrically-erasable programmable read-only memory (EPPROM), a storage drive, an optical disk, and any other suitable type of volatile or non-volatile memory that stores instructions to cause a programmable processor to perform the techniques described herein. In examples, memory resource 204 includes a main memory, such as a RAM in which the instructions are stored during runtime, and a secondary memory, such as a nonvolatile memory in which a copy of the instructions is stored.

The connection manager also includes a data collection engine 210, a profile creation engine 212, a resource matching engine 214, and a resource optimization engine 216.

The data collection engine 210 collects computing device data about computing device usage and user data about users' usage of computing devices in a centralized computing device environment. Specifically, the data collection engine 210 collects computing device data and user data about the computing devices 101 and the users 102 respectively. The data can be stored, for example, in the database 103 or another suitable data store or repository. The data can include historical data to track users' usage over time and/or to track performance of the computing devices over time. For example, a particular user may, over time, change what applications are used. The data collection engine 210 can continually collect data for users over time so that changes in use can be identified and utilized. Similarly, a particular computing device can be altered (e.g., a different graphics card can be installed, additional memory can be installed, a hard drive can be replaced, etc.), and such data can be collected and maintained.

In examples, the data collector collection 210 can receive data from existing monitoring systems that monitor computing devices 101 usage and users 102 usages of the computing devices 101. This data can be collected in an automated manner from interactions that the monitoring systems have with users and computing devices.

Examples of types data collected about each of the computing devices 101 can include the following: hardware specifications for each computing device of the computing devices 101 (e.g., hardware model and vendor; central processing unit (CPU) model, clock speed, and cache size; graphics processing unit (GPU) type and GPU memory size; memory size and clock speed; storage device type, capacity, and support information for external storage devices; network interface cards and speed; etc.); approximated computing device cost for each of the computing devices 101 based on hardware components (e.g., calculated from a predefined table with hardware components approximated cost included); how much time each of the computing devices 101 was used, which can be measured by monitoring remote desktop connections (e.g., actively used by a logged in user, reserved by a user but computing device was locked or logged off; background usage without having active user interaction, etc.); what applications are installed on each of the computing devices 101, which can be obtained from operating systems of each of the computing devices 101; and network information (e.g., latency between the connection manager 100 and each of the computing devices 101, network speed for each pool of computing devices 101, etc.).

Examples of types of data collected about the users 102 can include the following: time each user spends in each application, which can be monitored in an operating system of the respective computing device, measured in foreground time (i.e., when the user is actively interacting with the application) and background time (i.e., when a background process is executing without the user actively interacting with an application); time a remote desktop connection is active, which can be monitored from remote desktop applications and/or the operating system of the respective computing device, measured in time logged in with active usage, time reserved but not used, and time used in background processes; computing device utilization for the users 102 and their applications, which can be measured by hardware sensors (e.g., a temperature sensor) or which can measure total and per application hardware utilization (e.g., average CPU utilization, how much time a CPU spends at or above a threshold, average GPU utilization, average memory utilization, average storage utilization (e.g., how much data is created, moved, deleted; where data was created; where data was moved to/from; etc.), and average network utilization (e.g., amount of data transferred over a network connection)); and total and per application operating system utilization, which can be obtained from the operating systems of the respective computing devices 101 (e.g., average page faults, swap utilization, virtual memory utilization compared to physical memory, average amount of processes and threads, etc.).

Once the data about the computing devices 101 and the users 102 are collected, the profile creation engine 212 creates user profiles and computing device profiles. Profiling is the process of aggregating the collected data from the computing devices 101 and the users 102 into data sets that represent a particular computing device of the computing devices 101 or a particular user of the users 102. The profile provides information useful to the connection manager 100 to perform matching. The user profiles and/or the computing device profiles can be stored, for example, in the database 103 or another suitable data store or repository.

The profile creation engine 212 creates a user profile for each of the users 102 based on the collected user data for the users 102. For example, the profile creation engine 212 creates the user profiles by continuously monitoring the collected user data. A user profile contains the identification of a particular user and usage information, which summarizes how the particular user uses a particular computing device. FIGS. 3A, 3B, and 3C depict example user profiles 300A, 300B, and 300C respectively.

FIG. 3A depicts a user profile 300A for a user “John Doe” and provides usage information for John Doe. The usage information is broken down into “required” features (e.g., a low latency network and high GPU and memory) and “nice to have” (i.e., desired) features (e.g., fast storage and medium CPU). The user profile 300B for a user “Bob Andrews” and the user profile 300C for a user “Karen Smith” contain usage information as well as shown in FIGS. 3B and 3C, with variances between the user profiles 300A, 300B, 300C being based on how the users 102 use the computing devices 101.

These user profiles (e.g., the user profiles 300A, 300B, 300C) can be created using machine learning to model how users 102 use their respective computing devices 101 over time. Modeling can be based on user data collected on each of the users 102, computing device data collected about each of the computing devices 101, and remote desktop session data. The modeling can utilize historical data for the users and/or computing devices to identify and account for changes over time (e.g., changes in what application(s) a user uses, changes in when a user accesses a computing device, changes to a particular computing device's configuration, etc.). Examples of how components of such a model can be generated are as follows. First, the model determines a user's routine by identifying which applications the use uses including when and how long, by identifying how frequently an application is used (e.g., every 2 hours, every day, every morning, every Monday morning, after another application is used, etc.), and by determining how many parallel computing devices of the computing devices 101 and applications are being used at a time (foreground and background processing being considered). Next, the model monitors how well suited a particular computing device of the computing devices 101 is suited for a particular user of the users 102 based on the user profile for the particular user and the computing device profile for the particular computing device. This can be accomplished by comparing utilization data from the particular computing device (e.g., using temperature data, CPU percent usage, GPU percent usage, memory utilization, etc.) with data over time from the particular user and data over time from other users of the users 102 using similar application in other computing devices of the computing devices 101.

With continued reference to FIG. 2, the profile creation engine 212 also creates a computing device profile for each of the computing devices 101 based on the collected computing device data for the computing devices 101. In some examples, the profile creation engine 212 applies a machine learning model to the collected data for the computing devices to generate the computing device profiles.

The computing device profile for each of the computing devices 101 is created by comparing the computing device data for that computing device to predefine categories (e.g., memory, processor, storage, applications, etc.). These categories can be updated over time, such as when new hardware or new software applications are released. A computing device profile is a list of tags that are assigned to a computing device for each of its hardware capabilities. For instance, a computing device with 4 GB of memory might be tagged as “low” for its memory configuration while a computing device with 32 GB of memory might be tagged as “high” for its memory configuration.

FIG. 3D depicts a table 310 of an example computing device profile for three computing devices 311, 312, 313. Profiles for each of the computing devices 311, 312, 313 can include a workstation type 321, a memory (RAM) configuration 322, a processor (CPU) configuration 323, a graphics card (GPU) configuration 324, a storage configuration 325, an application configuration 326, an average usage amount of time 327, a physical location 328, and a cost 329. As shown in the example of FIG. 3D, each workstation profile for the computing devices 311, 312, 313 can include a tag (e.g., low, medium, high, slow, fast, etc. and combinations thereof) that provides a qualitative assessment of the associated configuration/aspect of the computing device compared to other computing devices. For example, as shown for the computing device 312, the processor (CPU) configuration 323 (12×3.8 GHz) is tagged as “high” while for the computing device 311 the processor (CPU) configuration 323 (4×3.4 GHz) is tagged as “low.” It should be appreciated that other, more, and/or different tags can be used in other examples.

The resource matching engine 214 matches users 102 to computing devices 101 based on the user profiles and computing device profiles. In examples, the machine learning model can be applied, using the user profiles and computing device profiles, to generate the matchings.

An example of matching is as follows, with reference to the examples of FIGS. 3A-3D. It is determined that John Doe uses a particular computing device of the computing devices 101 at 9 am to perform video editing tasks. Over time, John Doe's profile is created, with his continuous usage, and the resource matching engine 214 matches a computing device of the computing devices 101 that has video editing capabilities (e.g., video editing software applications, high memory, high GPU, and high storage) while respecting the computing device usage over time and cycling with similar computing devices.

In some examples, groups of users are created to pair users that have similar user profiles. Similarly, groups of computing devices can be created to pair computing devices that have similar computing device profiles. For example, if there are ten computing devices used for rendering and each has a similar configuration, these ten computing devices can be grouped in a “rendering pool” that is used by 3D modeling users or video editing users for use when rendering is desired. As another example, more common computing devices with lower hardware capabilities can also be grouped to create a pool for performing standard office tasks (e.g., email, word processing, spreadsheets, etc.) so that users that do not need high hardware specifications can connect to these lower hardware configured computing devices, saving the high hardware specification computing devices for more intensive tasks (e.g., rendering).

Once the matching is performed, the connection manager 100 can improve the matchings. For example, the resource optimization engine 216 provides recommendations to optimize the matching, such as to a system administrator, and/or provides recommend improvements regarding what changes to make in the centralized computing device environment. In some examples, a system administrator is notified of these recommendations. In other examples, the recommendations are automatically implemented in the centralized computing device environment. In such cases, the connection manager 100 can take action to implement the recommendations without any requirement of manual assistance. This can enhance the effectiveness of the matching and profiling by creating a closed-loop approach where the connection manager 100 monitors the usage of the computing devices 101, acts on it by creating new matchings (or modifying existing matchings), and then collects new data from the new matchings to evaluate the new matchings. In either case, once the recommendations are implemented, the connection manager can collect new user data and computing device data, analyze the new data, and make new recommendations for improvements/optimization. In this way, the connection manager continuously and iteratively improves the centralized computing device environment.

FIG. 4 depicts a computer-readable storage medium 404 comprising instructions for management of computing devices according to examples described herein. The computer-readable storage medium 404 is non-transitory in the sense that it does not encompass a transitory signal but instead is made up of storage components that store the instructions. The computer-readable storage medium may be representative of the memory resource 204 of FIG. 2 or another suitable memory and may store machine-executable instructions in the form of modules or engines. These instructions can be executed, for example, by the processing resource 202 of FIG. 2 or by another suitable processing device or system.

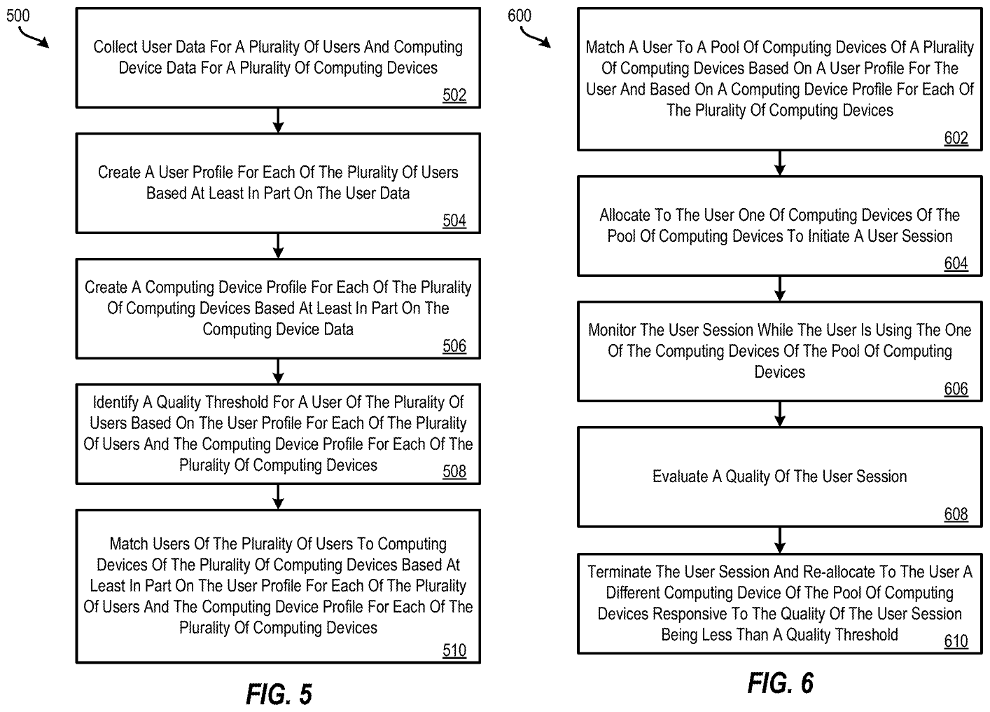

In the example shown in FIG. 4, the instructions include data collection instructions 410, profile creation instructions 412, resource matching instructions 414, and resource optimization instructions 416. In some examples, the computer-readable storage medium 404 stores the database 103 of FIG. 1 or is coupled to a storage device for storing the database 103. The instructions of the computer-readable storage medium 404 are executable to perform the techniques described herein, including the functionality described regarding the method 500 of FIG. 5 and/or the method 600 of FIG. 6. The functionality of these modules is described below with reference to the functional blocks of FIGS. 4 and 6 but should not be construed as so limiting.

In particular, FIG. 5 depicts a flow diagram of a method 500 for management of computing devices according to examples described herein. The method 500 is executable by a computer processing system such as the connection manager 100 of FIGS. 1 and 2. The method 500 is described with reference to the instructions stored on the computer-readable storage medium 404 of FIG. 4 and the components of FIGS. 1 and 2 as an example but is not so limited.

At block 502 of FIG. 5, the data collection instructions 410 collect user data for a plurality of users for each of the plurality of users and the computing device profile for each of the plurality of computing devices. The data can be stored in any suitable data store, such as the database 103 of FIG. 1.

At block 504, the profile creation instructions 412 create a user profile for each of the plurality of users based on the user data. Examples of user profiles are depicted in FIGS. 3A, 3B, 3C and described herein. In examples, the user profiles can be created using a machine learning model as described herein.

At block 506, the profile creation instructions 412 create a computing device profile for each of the plurality of computing devices based on the computing device data. An example of a computing device profile is depicted in FIG. 3D and described herein. According to examples described herein, the computing device profile can identify the plurality of computing devices based on hardware capabilities, software capabilities, and usage information. In examples, the computing device profiles can be created using a machine learning model as described herein.

At block 508, the resource matching instructions 414 identify a quality threshold for a user of the plurality of users based on the user profile for each of the plurality of users and the computing device profile for each of the plurality of computing devices. Examples of quality thresholds include an amount of processing, memory, and/or graphics to support a particular user's demands based on the types of applications the user uses. For example, a quality threshold for a user using video editing applications and three-dimensional rendering applications may be higher than a quality threshold for a user using basic email, web browsing, and office suite software. In some examples, the quality threshold can be a ranking for a user, with a higher ranking corresponding to a more powerful (e.g., higher processor, memory, graphics, storage, etc.) computing device. In some examples, the ranking can be a class of computing device (e.g., a basic computing device, a moderate computing device, an advanced computing device), with each computing device of each class being similarly configured.

At block 510, the resource matching instructions 414 match, to satisfy the quality threshold, a user or users of the plurality of users to a computing device or computing devices of the plurality of computing devices based on the user profile(s) and the computing device profile(s). That is, the matching is performed by identifying a quality threshold to be satisfied and then matching a user to a computing device to satisfy the quality threshold. This ensures that a user is matched to a suitable computing device to satisfy the user's typical usage. According to examples described herein, the matching can include pooling a subset of the plurality of users having similar user profiles. This enables a pool of users to be matched with a computing device rather than one particular computing device being matched with each user. For example, users that use a particular application at different times of day can be pooled together and can be matched with a computing device that executes this application. Thus, users can use the same computing device at different times of day to execute the particular application. Similarly, the matching can include pooling a subset of the plurality of computing devices having similar computing device profiles. For example, computing devices with similar hardware specifications can be pooled together. This enables a user to be matched with a pool of computing devices rather than one particular computing device. When the user initiates accessing a computing device, the user can access any of the computing devices in the group.

Additional processes also may be included. For example, the resource optimization instructions 416 can monitor the plurality of users and the plurality of computing devices to generate recommendations for improving at least one of the plurality of computing devices. Similarly, the resource optimization instructions 416 can monitor the plurality of users and the plurality of computing devices to generate recommendations for improving the matching. The monitoring can include collecting additional data for the plurality of users and the plurality of computing devices subsequent to implementing the recommendations for improving the matching, analyzing the collected additional data to generate additional recommendations for improving the plurality of computing devices, and implementing the additional recommendations for improving the plurality of computing devices. It should be understood that the processes depicted in FIG. 5 represent illustrations and that other processes may be added or existing processes may be removed, modified, or rearranged without departing from the scope of the present disclosure.

FIG. 6 depicts a flow diagram of a method 600 for management of computing devices according to examples described herein. The method 600 is executable by a computer processing system such as the connection manager 100 of FIGS. 1 and 2. The method 600 is described with reference to the instructions stored on the computer-readable storage medium 404 of FIG. 4 and the components of FIGS. 1 and 2 as an example but is not so limited.

At block 602 of FIG. 6, the resource matching instructions 414 match a user to a pool of computing devices of a plurality of computing devices. The matching is performed using a user profile for the user and a computing device profile for each of the plurality of computing devices. In examples, the plurality of computing devices are categorized into a plurality of pools. Each of the pools can have similarly configured computing devices (e.g., similar hardware and/or software configurations), and the configurations of computing devices of one pool differ from the configurations of the computing devices of another pool. For example, one of the pools can be a pool of computing devices configured for video editing (e.g., high performance GPUs, large amount of memory and storage, and video editing applications, etc.) while another of the pools can be a pool of computing devices configured for basic productive tasks such as email and web browsing (e.g., lower performance CPUs, basic GPUs, etc.). This enables matching a user to a pool of computing devices that are similarly configured. When the user requests access to a computing device, one of the computing devices of the pool of computing devices that are similarly configured and matched to the user are allocated to the user (see block 604).

At block 604, the connection manager 100 allocates to the user one of the computing devices of the pool of computing devices to initiate a user session. For example, when the user desires to connect to a computing device, a request is sent to the connection manager 100, and the connection manager 100 allocates a suitable computing device to the user based on the matching. A user session is then initiated.

At block 606, the resource optimization instructions 416 monitor the user session while the user is using the one of the computing devices of the computing devices that is allocated to the user. For example, the resource optimization instructions 416 monitors the user session by collecting data about the computing device during the user session.

At block 608, the resource optimization instructions 416 evaluate a quality of the user session. In some examples, evaluating the quality of the user session can include determining whether a user performance criterion is met based on the user data. An example of a user performance criterion can include, but is not limited to, an amount of time a user is actively interacting with an application, an amount of time a user is logged into a particular computing device, how much memory/processor/storage a user uses, etc. According to examples, a different computing device is allocated to the user responsive to determining that the user performance criterion is not met. For example, if a user's processor utilization exceeds a threshold (or exceeds a threshold for a period of time), the user performance criterion is determined not to be met, and re-allocation is performed (see block 610). As another example, if a user is logged into to a particular computing device for more than a threshold amount of time, the user performance criterion is determined not to be met, and re-allocation is performed (see block 610).

In some examples, evaluating the quality of the user session can include determining whether a computing device performance criterion is met based on the computing device data. An example of a computing device performance criterion can include, but is not limited to, an amount of time a computing device is used, hardware thresholds being exceeded (e.g., a processor operating at or above a threshold operating percentage, an amount of memory used at or above a threshold operating percentage, etc.), an amount of latency between the computing device and other computing devices, etc. According to examples, a different computing device is allocated to the user responsive to determining that the computing device performance criterion is not met. For example, if latency between the computing device and other computing devices is too great (i.e., above a latency threshold), the computing device performance criterion is determined not to be met, and re-allocation is performed (see block 610).

In some examples, the effectiveness of the matching is evaluated by evaluating the session quality. For example, high resource use by a user of a computing device may indicate that the user matched to that computing device needs more computing power. As another example, low resource use by a user of a computing device may indicate that the user can be matched with a lower-powered computing device instead of a more highly-powered computing device. In such cases, session quality is identified to improve and make changes to the matching. A session quality can be improved when the user profiles of certain user performance criteria match corresponding criteria of a class of computing devices allocated to them (e.g., a computing device class having a number or type of resources best matching the user).

With continued reference to FIG. 6, at block 610, the connection manager terminates the user session and re-allocates to the user a different computing device responsive to the quality of the user session being less than a quality threshold. This enables the connection manager 100 to re-allocate a computing device to a user based on how the computing device is performing and how the user is using the computing device. The method 600 can be performed continually, iteratively, at particular times, etc., to continually monitor the matching. Accordingly, as users' behavior or needs change over time or as computing devices age (or are added, upgraded, replaced, etc.), for example, re-matching and/or re-allocating can be performed.

Additional processes also may be included, and it should be understood that the processes depicted in FIG. 6 represent illustrations and that other processes may be added or existing processes may be removed, modified, or rearranged without departing from the scope of the present disclosure.

It should be emphasized that the above-described examples are merely possible examples of implementations and set forth for a clear understanding of the present disclosure. Many variations and modifications may be made to the above-described examples without departing substantially from the principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements are intended to be supported by the present disclosure.

What is claimed is:

1. A non-transitory computer-readable storage medium comprising instructions that, when executed by a processing resource, cause the processing resource to:
collect user data for a plurality of users and computing device data for a plurality of computing devices;
create a user profile for each of the plurality of users based on the user data;
create a computing device profile for each of the plurality of computing devices based on the computing device data;
identify a quality threshold for a user of the plurality of users based on the user profile for the user and the computing device profile for each of the plurality of computing devices; and
match, to satisfy the quality threshold, the user of the plurality of users to a computing device of the plurality of computing devices based on the user profile for the user and the computing device profile for the computing device.

2. The non-transitory computer-readable storage medium of claim 1, wherein the instructions cause the processing resource further to monitor the plurality of users and the plurality of computing devices to generate recommendations for improving the matching.

3. The non-transitory computer-readable storage medium of claim 2, wherein the instructions cause the processing resource further to:
collect additional data for the user of the plurality of users and the computing device the plurality of computing devices subsequent to implementing the recommendations for improving the matching;
analyze the collected additional data to generate additional recommendations for improving the computing device of the plurality of computing devices; and
implement the additional recommendations for improving the computing device of the plurality of computing devices.

4. The non-transitory computer-readable storage medium of claim 1, wherein the computing device profile identifies the plurality of computing devices based on hardware capabilities, software capabilities, and usage information.

5. The non-transitory computer-readable storage medium of claim 1, wherein the matching further comprises pooling a subset of the plurality of users having similar user profiles.

6. The non-transitory computer-readable storage medium of claim 1, wherein the matching further comprises pooling a subset of the plurality of computing devices having similar computing device profiles.

7. The non-transitory computer-readable storage medium of claim 1, wherein the user profile is created using a machine learning model.

8. The non-transitory computer-readable storage medium of claim 1, wherein the computing device profile is created using a machine learning model.

9. The non-transitory computer-readable storage medium of claim 1, wherein the instructions cause the processing resource further to monitor the plurality of users and the plurality of computing devices to generate recommendations for improving the computing device of the plurality of computing devices.

10. A method comprising:
matching, by a processing resource, a user to a pool of computing devices of a plurality of computing devices based on a user profile for the user and based on a computing device profile for each of the plurality of computing devices;
allocating to the user one of computing devices of the pool of computing devices to initiate a user session;
monitoring, by the processing resource, the user session while the user is using the one of the computing devices of the pool of computing devices;
evaluating, by the processing resource, a quality of the user session; and
terminating, by the processing resource, the user session and re-allocating to the user a different computing device responsive to the quality of the user session being less than a quality threshold.

11. The method of claim 10, wherein evaluating the quality of the session comprises determining whether a user performance criterion is met.

12. The method of claim 11, wherein the re-allocating is performed responsive to determining that the user performance criterion is not met.

13. The method of claim 10, wherein evaluating the quality of the session comprises determining whether a computing device performance criterion is met.

14. The method of claim 13, wherein the re-allocating is performed responsive to determining that the computing device performance criterion is not met.

15. A system comprising:
a plurality of computing devices remotely accessible by a plurality of users; and
a connection manager comprising a memory having computer readable instructions stored therein and a processing resource for executing the computer readable instructions, the computer readable instructions comprising:
a data collection engine to collect computing device data and user data;
a profile creation engine to create a user profile for each of the plurality of users and a computing device profile for each of the plurality of computing devices;
a resource matching engine to match a user of the plurality of users to a computing device of the plurality of computing devices; and
a resource optimization engine to evaluate the match and to provide a recommendation to optimize the match.
